(19) United States
(12) Patent Application Publication
(10) Pub. No.: US 2008/0057943 A1
(43) Pub. Date: Mar. 6, 2008

(54) REMOTE CALL FORWARDING IN A WIRELESS NETWORK FROM A TELECOMMUNICATIONS DEVICE INSIDE OR OUTSIDE THE WIRELESS NETWORK

(75) Inventors: Jun Shen, Redmond, WA (US); Ming Zhang, Bellevue, WA (US)

Correspondence Address: POWELL GOLDSTEIN, LLP, 901 NEW YORK AVENUE, N.W., 3RD FLOOR, WASHINGTON, DC, 20001-4413, US

(73) Assignee: CINGULAR WIRELESS II, LLC, Atlanta, GA (US)

(21) Appl. No.: 11/470,451

(22) Filed: Sep. 6, 2006

(51) Int. Cl. H04Q 7/20

(52) U.S. Cl. 455/425

(57) ABSTRACT

At least two different methods and various combinations of apparatus are disclosed for remotely actuating call forwarding when the subscriber of a wireless network does not have their mobile device with them or have access to the internet. In one method the subscriber dials a string of digits comprising a wireless carrier routing string to route the call to within their wireless network. A service feature invoking string of a single digit or two dialed digits is entered to identify a sub-address appendix. More importantly, the subscriber identifies themselves to their wireless network by entering a sequence of dialed digits, preferably their subscriber number (SN) and a personal identifier or PIN where the feature invoking string separates the SN from the PIN entry. Finally, the subscriber, if calling from the destination phone enters a digit signifying they have reached the destination. If the subscriber is calling from an intermediate phone along the way to their destination, the subscriber enters the entire destination telephone number. An alternative embodiment involves the use of interactive voice response equipment within the wireless network accessed by the caller inside or outside the wireless network. The call forwarding service feature or other features such as entering a service feature cancellation command, a follow me list of telephone numbers and scheduled times or a list of priorities for receiving calls (such as a friends and family list versus junk mail) may be actuated from an intermediate phone or a destination phone inside or outside the network.

### TECHNICAL FIELD

The technical field relates to wireless telecommunications networks and services thereof, and, more particularly, to a remote call forwarding service in a wireless network from a telecommunications device inside or outside the wireless network.

### BACKGROUND OF THE INVENTION

The assignee of this patent application, a wireless service provider in the United States, provides a number of alternative ways to forward a wireless subscriber's incoming telephone calls from his or her wireless telephone number to a different telephone number. For example, a Cingular customer may use their personal computer to access menu screens through the World Wide Web at www.cingular.com. The menu screens permit a Cingular wireless network subscriber to identify themselves at the Cingular Web site, select a call forwarding service for his or her wireless telephone for which the subscriber is authorized, input the telephone number to which incoming calls should be directed and select “ok.” As a consequence, calls to the Cingular subscriber will from then on forward to the input telephone number until this call forwarding service is canceled. After enabling call forwarding from the web site, the Cingular subscriber will receive incoming calls to their cellular phone at the entered call forward telephone number until this call forwarding service is canceled through a related cancel process. After the Cingular subscriber returns to his or her mobile device, the subscriber can cancel this call forwarding service in a similar manner through the same Web site or via other means.

Call forwarding services may alternatively or additionally be activated through the wireless telephone. For many of Cingular's wireless telephones, hereinafter referred to as mobile devices (which may include portable terminals such as personal computers, and personal data assistants) that communicate using the global system for mobile communications (GSM) standards, for example, Cingular also provides “star” services. The * or “star” symbol of the mobile device dial or keyboard may provide access within the Cingular wireless network to call forwarding and other services, including the ability to request and receive an outstanding bill amount. For example, after dialing *21* from a Cingular subscriber's mobile device, the subscriber can then enter, for example, a ten digit telephone number to which calls are to be directed. By then entering the # sign found on a standard dial, a Cingular subscriber may complete the call forwarding invocation process. An incoming call to his or her mobile device will then be forwarded from their mobile device by the Cingular network to the entered telephone number. As suggested above, this call forwarding service may be canceled from the subscriber's mobile device or by cancellation through the Cingular web site as discussed above.

Various call forwarding schemes are described by U.S. Pat. Nos. 5,867,784; 6,141,545 (remote call forwarding to a PBX extension from a cellular phone); U.S. Pat. Nos. 6,188,888; 6,584,316; 6,615,037 and 6,718,026, each of which are incorporated by reference in their entirety. Moreover, it is known to be able to enter a follow-me schedule of telephone numbers associated with different times of a day so that a given telephone network may forward calls from a subscriber's network telephone number to a first number between certain hours, to voice-mail for certain hours, to a work telephone for certain hours and so on through, for example, a weekly schedule. It is also known in some networks that a network subscriber may also attach priorities to incoming calls from certain identified callers determined through caller identification such that certain calls from friends and family are connected through and junk callers (having unidentified, toll-free or anonymous telephone numbers) are instead sent to voicemail or even dropped.

In some instances, however, a wireless network subscriber, may wish to use a call forwarding service, for example, after leaving on travel, leaving their cell phone and personal computer behind. Assuming that the wireless network subscriber is either inside or outside their cellular network and cannot use the Internet, the subscriber may still want to activate a call forwarding service. For example, the subscriber may wish to actuate call forwarding to their vacation destination telephone from that telephone or from a telephone visited along the travel route, for example, a pay station at an airport on the way to their destination. The vacationing subscriber may be able to use a cellular telephone of a fellow passenger, the fellow passenger using the same or another wireless carrier. The subscriber may even be out of the country on international travel and still wish to actuate a call forwarding service for forwarding calls to their destination telephone.

According to numbering plan standards, for example, a third generation (3G) partnership project (PP) technical specification (TS) 23.003 V7.0.0 (2006-06) for group core network and terminals; numbering addressing and identification, a structure for mobile station international public switched telephone network/ISDN numbering is described (MSISDN). The MSISDN telephone number comprises a country code (CC) followed by a national (significant) mobile number (NMN) in turn comprising two parts. The NMN comprises a national destination code (NDC) and a subscriber number (SN). At least one NDC is allocated to each public land mobile network (PLMN) in the country designated by the country code.

In North America, a series of area codes prevails for the United States, Canada and other North American countries replacing the internationally used country code (CC) with a “1”. The North American area code and a next sequence of three digits comprising an exchange code together denote the wireless carrier. In either the case of the international GSM standard or the North American numbering plan, it is known that a plurality of dialed digits represents wireless carrier routing information which is used by the PSTN/ISDN to route a call to or via a wireless carrier of choice. Continuing the discussion of the wireless network subscriber on holiday in the United States, for example, calling from a call originating terminal inside or outside the wireless network, the subscriber may use a call originating terminal inside or outside his or her wireless network to call someone inside their wireless network such as a family member or friend. The wireless subscriber calling from outside the wireless network reaches a service control point (SCP) in the PSTN when they originate a call from a terminal outside their wireless network. At the PSTN SCP is located access to a number plan administration center which points the direction to the wireless carrier of the called mobile device inside the wireless network. Once the wireless carrier of choice is reached, for example, via a mobile switching center (MSC) of the dialed wireless carrier, there exists subscriber number (SN) data which identifies a particular subscriber, such as the family member or friend inside the wireless network. In turn a table for that subscriber may be referred to for determining a location area code (LAC) where that subscriber's mobile device last registered. Such a table or home location register HLR is a separate network node. It is connected to a mobile switching center (MSC) or a media gateway either via the traditional SS7 network or an IP, ATM or other network. (Henceforth, in the specification, MSC will be used to encompass any such gateway or equivalent center.) When a subscriber roams and his or her mobile device registers in a visited mobile network, a subscriber's record is downloaded from a HLR to a copy visitors' location register (VLR) (co-located with the MSC.) A radio network controller (RNC) or base station controller (BSC) does not need access to the data since the call processing decision is made at an MSC or Media Gateway level of the wireless network until the call is processed through to the called party. The serving MSC field in an HLR identifies an MSC which in turn knows the subscriber mobile device's location area code (LAC) data. The MSC then can identify a set of base stations within the LAC where the called subscriber's mobile device last registered. For an incoming call, the MSC causes the set of base stations within the LAC to page for the mobile device under the control of an RNC or BSC as long as the called subscriber's mobile device is “on” (powered) and receiving calls in cells or sectors associated with the base station. If within range, the “on” and registered mobile device receives the call.

The composition of the MSISDN number for a wireless subscriber mobile device is used as a global title address in the signaling connection control part (SCCP) for routing messages to the home location register (HLR) of the mobile device. The country code (CC) and the national destination code (NDC) of the NMN provide such routing information. If further routing information is required, it is maintained in the few digits of the subscriber number (SN).

A sub-address may be appended to an MSISDN number for use in call setup and in supplementary service operations where the sub-address is transferred to terminal equipment denoted by the MSISDN number. The maximum length of a sub-address is dictated by GSM and comprises no more than twenty octets, including one octet to identify the coding scheme for the sub-address.

In North America, it is also known to provide toll-free access to services and billed access to services according to the North American numbering plan. For example, 1-800 and 1-888 are well known as prefixes for a toll-free number access, for example, for services such as travel reservations services. Other prefixes such as a 1-900 prefix are known to identify billable or toll services, such as paid-for entertainment and other services billable by the minute. These services are typically available from an inter-exchange carrier such as AT&T Corp.

AT&T Corp. provides 1-800 telephone numbers, for example, 1-800-CALL-ATT to access its services. Dialing this number connects a caller to a network platform for providing help services which may, in turn, be provided by interactive voice response (IVR) systems. For example, calling the toll-free telephone number connects a caller to an interactive voice response system providing a menu of opportunities for receiving data from accessible databases. In response to voiced queries generated by the interactive voice response system, a caller inputs selections by voicing them or entering dialed digit sequences and receives further menu selections or is requested to enter further data via the dial or intelligible word data which may comprise commands for reaching a solution to a particular problem of interest to the caller.

Local exchange carriers including wireless carriers have certain three digit telephone numbers through which they provide services such as 911 emergency services, 411 information services and 611 repair services. Also, historically, as in the present, a subscriber may dial “0” for operator assistance. These are specialized services and, typically, are not used as an access for services such as call forwarding. For example, calling 611 typically accesses a service provided by wireless carriers to their subscribers in need of assistance and may include live agent support.

Also, a format is known for an international numbering plan scheme for providing access to a wireless network to a subscriber finding themselves inside or outside the network of their wireless carrier of choice in GSM (and UMTS), but there is presently no known access to services such as remote call forwarding to a subscriber finding themselves inside or outside of their wireless network without their mobile device and without internet access.

### SUMMARY OF THE INVENTION

The problem of providing remote call forwarding to a subscriber finding themselves inside or outside their wireless network and without internet access is solved by providing a method and apparatus for actuating call forwarding remotely in a wireless network from a telecommunications device inside or outside the wireless network. The subscriber dials a sequence of, for example, six (international minimum) or seven digits up to ten or eleven digits (depending on whether a “1” prefix is required in the North American area dialed from) for identifying their wireless carrier and routing their call via a mobile switch center (MSC) to a network platform which may provide interactive voice response services or either the MSC or network platform otherwise act upon following dialed digits. The sequence should be a dialable string, acceptable to the PSTN, which helps the serving network decide that the call needs to be routed to the subscriber's wireless network. A signal transfer point (STP) of the PSTN (if the call is from outside) or the wireless network (if the call is from inside) knows to route the call to the special call forwarding network platform for further processing with the addition of the one or two dialed digit feature code (which may be the required octet).

If the MSC or network platform is adapted to receive sequences of dialed digits, the MSC or network platform is programmed to accept the next two dialed digits after a minimum of six (international) up to similarly ten or eleven dialed digits (if “1” plus an area code is required) as the specific feature selection octet indicator (one dialed digit and filler data or two dialed digits), and a previously entered dialed digit string and/or the sequence of digits following the required GSM octet of two dialed digits are processed to verify subscriber identity. To verify the subscriber's identity, typically by subscriber number (SN) and a personal identifier (PIN), the platform processes a dialed sequence of digits indicating same. Once the subscriber's identity is determined and a call forwarding service identified by the two digit octet of bits required by GSM, typically at the location register, the network platform receives a further sequence of digits representing the destination telephone number inside or outside the wireless network to which calls may be directed from then forward. The remote call forwarding telephone number may be identified through a shortened sequence or even a single digit indicating that the telephone number identified through caller identification (caller id) may be used as the call forwarding telephone number. In other words, the subscriber finding themselves inside or outside their wireless network has already reached their destination telephone number and is not dialing from an interim telephone such as a coin telephone, along the way.

If the MSC of the wireless network processes the digits following the six or seven digit carrier routing string in place of an adjunct network platform, the MSC may translate the subsequent string into a compressed data string for forwarding to the network platform. For example, the SS7 signaling system or a virtual channel outside SS7 can be used to forward compressed data packets to the network platform. Whether or not the MSC performs such a translation into compressed data, the network platform processes what data is not processed by the MSC and contacts the location register of the inside or outside-the-network wireless subscriber and updates the register to show the destination call forwarding telephone number. In this way, the subscriber needs only to remember his or her carrier access code of six digits, their subscriber number (SN), the one or two digit feature code for remote call forwarding service (which may be an octet comprising one dialed digit and filler of error correction data to meet the octet requirement), and their verification code such as a PIN. The subscriber then enters his or her ten digit telephone destination number or a substitute code signaling their wireless network that their network may use the call identification number forwarded trough SS7 as the new call forward telephone number. If the subscriber can so remember, and because GSM permits a twenty octet sub-address (equivalent to forty dialed digit key actuations), the dialed digit string, according to one aspect of the invention, can be increased in length to permit any one of a number of additional features for a remote call forwarding service such as automatic cancellation on a given date and time, a follow me sequence of telephone numbers for different dates and times and a sequence of telephone numbers of friends, family and business associates whose calls will be permitted to reach the subscriber on vacation.

If the network platform reached within the wireless network has associated interactive voice response services, the wireless subscriber does not need to remember a dialing string comprising a plurality of digit sequences. In stead, the subscriber may be queried and answer verbally or, by dialing their response to the query, enter sufficient data to invoke remote call forwarding. An IVR system may provide a script for asking further related questions such as whether the subscriber would wish now to enter a remote call forwarding cancellation date and time, a follow-me schedule, or a list of callers by telephone number for call completion or call screening.

Related to each method of invoking remote call forwarding from inside or outside a wireless network is related MSC or network platform apparatus. The network platform apparatus is reached via a mobile switching center within the wireless network responsive to entry of the sequence of digits for identifying their wireless carrier. The network platform includes a controller and a link for reaching a home location register (HLR) or visitors' location register, henceforth, collectively, a location register for simplicity. If the network platform is equipped with interactive voice response (IVR), then, the subscriber simply responds to a series of queries. If the network platform is not so equipped for IVR, then, the network platform invokes call forwarding from interpretation of receipt of sequences of digits for service invocation, subscriber verification, and identification of the destination telephone number, service cancellation data or other data of the GMS sub-address.

Consequently, in accordance with a first aspect of examples of the invention, a method of actuating call forwarding remotely in a wireless network from a telecommunications device inside or outside the wireless network comprises receiving a dialed string of digits comprising a sequence of dialed digit sequences having a first dialed digit sequence for routing a call from the telecommunications device inside or outside the wireless network to within the wireless network, i.e a network platform for providing an identified service or service feature, interpreting data representing a second sequence of digits of the dialed string of digits for verifying caller identity within the wireless network, interpreting data representing at least one dialed digit following the second sequence of digits of the dialed string of digits as indicative of a destination telephone number of a telecommunications device inside or outside the wireless network to which calls to a wireless device of a verified caller are to be forwarded. For example, during subscriber verification, after dialing a subscriber number, the method includes the step of interpreting a sequence of one or two digits of the dialed string of digits as a service feature invoking string of digits (the required GSM octet) within the wireless network. As can be seen from this embodiment, the caller simply dials a predetermined string of digits for accessing their wireless network from any telephone inside or outside their wireless network and effectuates a change therein of call routing information for their mobile device.

According to a further aspect of examples of the invention, a method of actuating call forwarding remotely from a telecommunications device inside or outside the wireless network comprises receiving a dialed string of digits comprising a sequence of dialed digit sequences having a first dialed digit sequence for routing a call from the telecommunications device inside or outside the wireless network to the wireless network, interpreting a service feature invoking request in the wireless network, connecting the call to a network platform including interactive voice response equipment for providing the feature, the interactive voice response equipment for requesting verbal or dialed digit sequences, interpreting input data for verifying caller identity, and interpreting further input data as indicative of a destination telephone number of a telecommunications device inside or outside the wireless network to which calls to a wireless device of a verified caller are to be forwarded.

According to a further aspect of examples of the invention, a network apparatus of a wireless network is provided to which an incoming call has been routed from inside or outside the wireless network, the network apparatus being connected to the incoming call according to a first dialed digit sequence of a dialed string of digits comprising a plurality of dialed digit sequences, the network apparatus comprising a controller having access to a location register, the controller interpreting a second sequence of digits of the dialed string of digits for verifying caller identity, and interpreting a third sequence of digits of the dialed string of digits as indicative of a destination telephone number of a telecommunications device outside the wireless network to which calls to a wireless device of a verified caller are to be forwarded and the location register, responsive to a control signal from the network apparatus, indicating routing information for the incoming call to be routed according to the fourth sequence of digits. In order to provide the required GSM octet, the caller verification data may involve inputting a subscriber number (SN), at least one dialed digit for selecting a feature to make up, for example, a recognizable routing string of between six (international) and eleven dialed digits to permit a GSM sub-address which may comprise the PIN and destination call forward telephone number (among other data as discussed above: service feature cancellation date and time, follow-me schedule and such).

According to yet a further aspect of examples of the invention, a network platform of a wireless network is provided to which an incoming call has been routed from inside or outside the wireless network by a mobile switching center within the wireless network, the network platform being connected to the incoming call according to a first dialed digit sequence of a dialed string of digits comprising a plurality of dialed digit sequences, the network platform comprising a controller having access to a location register, the controller having an associated interactive voice response system, the controller receiving first data responsive to a voice request of the interactive voice response system, interpreting the first data as service feature data, receiving second data responsive to a voice request of the interactive voice response system, interpreting the second data for verifying caller identity at the network platform, and receiving third data responsive to a voice request of the interactive voice response system, and interpreting the third data as indicative of a destination telephone number of a telecommunications device inside or outside the wireless network to which calls to a wireless device of a verified caller are to be forwarded and a link, responsive to the controller, from the network platform to the location register, the location register responsive to a control signal sent over the link from the network platform, indicating routing information for subsequent incoming calls to a mobile device associated with the caller identity data to be routed according to the third data. The IVR equipment of this network apparatus may request further data entry for service feature cancellation, a follow-me schedule, a call filtering list and the like.

These and other aspects of processes and apparatus for remote call forwarding in a wireless network from a telecommunications device inside or outside the wireless network will become apparent from studying the drawings and the detailed description of the drawings.

### BRIEF DESCRIPTION OF THE DRAWINGS

FIG. 1 is a drawing showing the structure of a mobile station's PSTN/ISDN telephone number (MSISDN) comprising country code and a national mobile number, the latter including a national destination code and a subscriber number.

FIG. 2 is a drawing showing an exemplary dialing string of numbers for remotely actuating a call forwarding service from a telecommunications device for a mobile device's MSISDN from inside or outside their wireless network and without using the internet.

FIG. 3 is a drawing showing the routing of a typical incoming call through the PSTN/ISDN to a network platform of a subscriber's wireless network having access to the subscriber's location register of their mobile device. By way of example, the call actuates remote call forwarding by changing the destination telephone number from a subscriber's MSISDN number to an MSISDN compatible telephone number of a destination telephone which may or may not be the telephone number of the station apparatus used for making the service feature actuation call.

FIG. 3a depicts a second routing embodiment where the network platform depicted in FIG. 3 may comprise interactive voice response (IVR) apparatus and software.

FIG. 4 is a flowchart showing the processes of interpreting the exemplary dialing string of FIG. 2 and routing a call as per FIG. 3 for actuating remote call forwarding.

FIG. 5 is a flowchart showing the processes of routing a call as per FIG. 3a to a network platform associated with an interactive voice response system and actuating remote call forwarding via the interactive response system.

### DETAILED DESCRIPTION

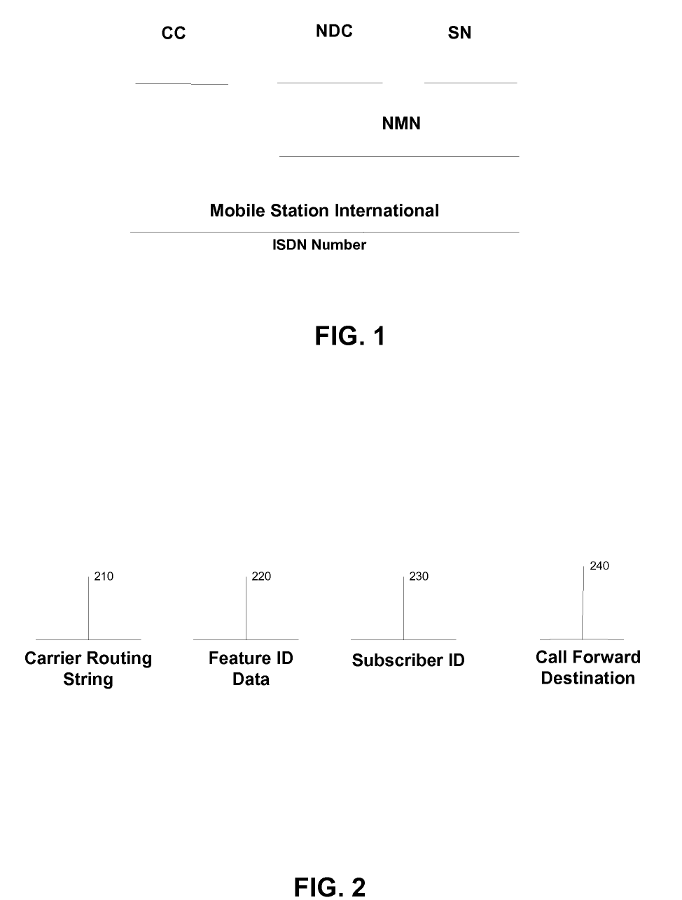

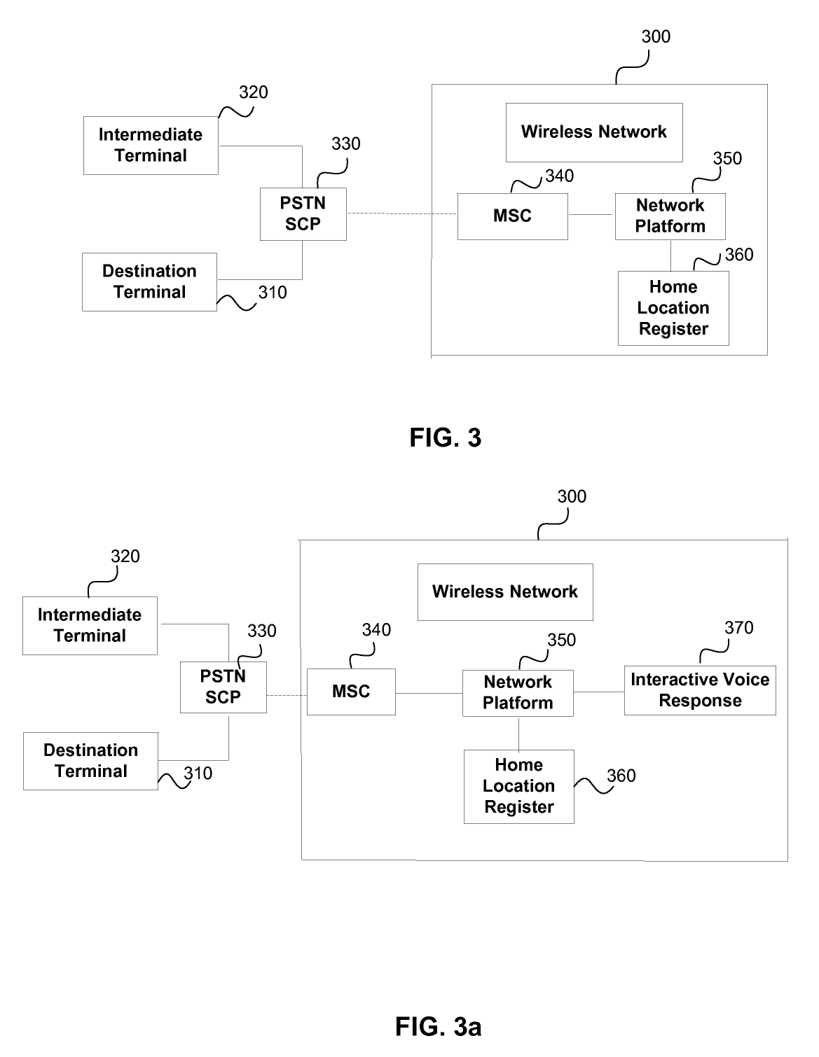

FIG. 1 is a drawing showing the structure of a mobile station's PSTN/ISDN telephone number (MSISDN) comprising country code and a national mobile number, the latter including a national destination code and a subscriber number. As discussed above, a PSTN/ISDN telephone number comprises a country code (CC) followed by a national (significant) mobile number (NMN) in turn comprising two parts. The national mobile number NMN comprises a national destination code (NDC) and a subscriber number (SN). At least one NDC is allocated to each public land mobile network (PLMN) in the country. In the United States and throughout North America, a series of area codes prevails and covers the United States, Canada and other North American countries replacing the country code. Referring briefly to FIG. 3, a service control point (SCP) of a PSTN 330 connected to a call originating terminal 310, 320 outside a wireless network 300 to which an originating call is directed is the first to receive a dialed digit string and interprets the first six or seven digits as carrier routing data for identifying the destination wireless carrier (PLMN) to which the call should be routed. The first number of a reference character pointing to an element of a figure will denote the figure in which that element first appears, for example, wireless network 300 first appears in FIG. 3. The GSM standard and the North American numbering plan provide that a plurality of dialed digits represents wireless carrier routing information which is used by the PSTN/ISDN 330 to route a call to a wireless carrier of choice. Once the wireless carrier of choice is reached, there exists subscriber number (SN) data which identifies a particular subscriber and in turn a table for that subscriber may be referred to for determining a location area code (LAC) for that subscriber where that subscriber's mobile device last registered. Such a LAC table is typically maintained at the location of a radio network controller (RNC) or base station controller (BSC), which may be associated with a mobile switching center 340 to complete a call to an “on” and registered mobile device or to a special adjunct network platform 350 upon receipt of a feature code. The location area code (LAC) typically identifies a set of base stations where the subscriber's mobile device last registered. For an incoming call, that set of base stations pages for the mobile device which may be powered “on” and receiving calls. If within range, the “on” and registered wireless telephone receives the call.

Referring again to FIG. 1 with reference to FIG. 3, for example, the composition of the MSISDN number for a wireless subscriber mobile device is used as a global title address in the signaling connection control part (SCCP) for routing messages to the location register 360 of the mobile device (HLR is the mobile device is home or a VLR is the device has roamed to a new territory). The country code (CC) and the national destination code (NDC) provide such routing information. If further routing information is required, it is maintained in the few digits of the subscriber number (SN).

A sub-address may be appended to an MSISDN number for use in call setup and in supplementary service operations where the sub-address is transferred to terminal equipment denoted by the MSISDN number. The maximum length of a sub-address is dictated by GSM to comprise no more than twenty octets, including one octet to identify the coding scheme for the sub-address. An octet is an eight bit byte of data where eight bits may comprise two four bit portions. In North America, there exist sixteen button four by four key matrix dials for federal government purposes such that four bits of data may represent one touchtone key actuation. Consequently, one aspect of the invention is to enter one or two predetermined dialed digits after a minimum of six (international) up to approximately ten or eleven digits have been entered (eleven in North America where a “1” prefix is required) for service feature actuation and to signal the wireless carrier that subsequently received or previously received dialed digits make up a GSM feature sub-address or routing data.

In North America, it is also known to provide toll-free access to services and billed access to services according to the North American numbering plan. For example, 1-800 or 1-888 are well known as providing toll-free number access, for example, for services such as travel reservations services. Other prefixes such as 1-900 are known to identify billable or toll services such as psychic and such paid-for entertainment and other services billable by the minute.

In compliance with FIG. 1 and the GSM, North American and other standards and in accordance with a methodology for achieving remote call forwarding from a telephone outside a wireless network, a subscriber inside or outside their wireless network and without their mobile device or internet access may dial a string of digits which comprises at least a first string of six (international) or seven digits from the remote telecommunications device outside the subscriber's wireless network. For example, the caller may enter this string of digits at a coin telephone at an airport or railroad station, from another's cellular telephone or from the destination telephone terminal to which the caller would wish their incoming calls forwarded.

An example of a minimum string of routing digits is seven in North America because according to many networks such a sequence of digits constitutes a minimum for call processing and routing. Most jurisdictions require a “1” prefix and others require “1” plus an area code as well. So a maximum string of routing digits is 11 or even more digits, for example, when attempting to reach an international wireless carrier outside the North American Numbering Plan.

FIG. 2 is a drawing showing an exemplary dialing string of numbers for remotely actuating a call forwarding service feature from a telecommunications device for their mobile device's MSISDN from inside or outside their wireless network and without using the internet. The exemplary dialing string as will be explained herein comprises a minimum length string of twelve dialed digits (assuming 6 international routing minimum, one for an octet feature appendix, four digit PIN subscriber verifier and one for destination). The dialed digit sequences may comprise a first sequence of numbers 210 for seeking to route a call from the telecommunications device inside or outside the subscriber's wireless network to a mobile switching center and/or eventually to a service or service feature network platform, both the switching center and the platform being within the wireless network. The entry of such a dialing string and call routing will now be described with reference to FIG. 3.

As suggested above, a first dialed digit sequence 210 of at least, for example, six digits (seven if a “1” prefix is required locally) and which may not include non-standard dialed digits such as a # or * digit is entered per FIG. 3 at an intermediate location 320 or a destination location 310 for interpretation within a public switched telephone network (PSTN) 330 that is not wireless network 300. The intermediate location 310 or 320 need not be outside the wireless network 300 so PSTN which may be an internet network, ATM network or any other network of a PSTN may be eliminated from the call if made from within network 300. For example, in Maryland within the United States, one may dial 1 301 908 XXXX where X may be any standard routing digit or SN collection for the subscriber and reach a wireless mobile switching center 340, for example, (or media gateway or other equivalent gateway or center) for a given wireless network, which may represent the wireless network 300 in which mobile switching center 340 is located. Consequently and in fact, only six or seven digits 1 301 908 are sufficient to identify to network apparatus within the dialed wireless carrier that a call, depending on the next digit sequence up to three digits, may be routed from the mobile switching center 330 to a network calling platform 350.

Once an entire dialing string which may comprise an appendix or routing data allowed by GSM is received at mobile switching center 340, at least a portion of the dialing string and appendix comprising service feature id data 220, subscriber id data 230 and call forward destination data 240 is forwarded over link 335 within the wireless network 300 from mobile switching center 340 to network platform 350.

FIG. 3 is a drawing showing the routing of a typical incoming call through the PSTN/ISDN 330 via an SCP to a network platform 350 via an MSC 340 of a subscriber's wireless network 300 having access to the subscriber's home location register 360 of their mobile device. By way of example, the call actuates remote call forwarding by changing the destination telephone number from a subscriber's MSISDN number to an MSISDN compatible telephone number of a destination telephone which may or may not be the telephone number of the station apparatus used for making the service feature actuation call.

If the entire sequences of digits 220, 230 and 240 are forwarded to network platform 350, a controller of network platform 350 receives and interprets service feature id data 220. The feature identification data 220 (for example, following, 1 301 908 and an SN portion of verification sequence such as 3156) if it comprises a portion of an appendix may include one or two natural number such as 0-9 or preferably a * sign indicating remote call forwarding. The service feature identification data 220, if immediately following a six digit carrier routing string 210 cannot typically contain non-standard dialed digit data such as a # or * sign. The subscriber will dial a portion of a verification sequence 230 before and after the service feature identification data 220. This portion of data 230 preferably comprises the SN of their mobile device. In fact, the subscriber has, in our example, thus far dialed 1 301 908 3156 (their own number) (a single digit feature identifier such as *) and then their regular four digit personal identification number (for example, 2174, the last four digits of their social security number) so the wireless carrier has received the subscriber number followed by just one dialed digit, a star, representing remote call forwarding. Rather than forward the call immediately on receiving 1 301 908 3156 to a network platform, mobile switching center 340 may verify the subscriber and obtain their service profile and translate the SN, and remaining dialed sequence including an appendix that it receives in order to compress the data transmitted between itself and network platform 350 over an SS7 link to the platform or use another form of link such as a data link (virtual channel). The compression of the remaining dialed digits may represent an intelligible data representation of digit sequences 220, 230 and 240 including a sub-address octet, eight bit byte as service feature identifier 220 signaling the beginning of up to forty following compressed dialed digits.

Continuing the dialed example introduced above, the dialed sequence 1 301 908 3156* may signal the mobile switching center to collect the following sequences of digits (2174) (201 825 1723) and interpret the sequences in parenthesis as follows. The single digit (or possibly double digit) sequence * or 21 or other predetermined octet may indicate to either the mobile switching center 340 or, if received at the network platform 350, service feature identification data 220 representing a call forwarding service and the identity of a sub-address to follow. Only one or two digits are required to identify feature identification data which may be simply a binary choice between one or another service feature or at most represent ten or one hundred feature selections. Consequently, mobile switching center 340 may translate service feature identification data into compressed data for forwarding to network platform 350.

Next consider subscriber identification data 230. One example of subscriber identification data may be (3156) (2174) where the first digits 3156 identify the subscriber wireless number SN of FIG. 1. As described above, these may be separated by the feature/sub-address identifier * or another predetermined one or two dialed digit octet identifying the GSM sub-address. The second set of four digits of subscriber identification data 230 may represent the subscriber's birthday or other verifiable data. Also, a personal user identification comprising at least four digits (up to seven digits or characters) can be entered, in this instance, 2174. MSC 340 may verify the subscriber identity and forward compressed subscriber number (SN) data to network platform 350 or pass on the subscriber verification task to network platform 350.

An SN and four digit identifier (PIN) may be considered sufficient for subscriber verification purposes. Studies have shown that up to a seven character PIN may be recalled by a user. Consequently, one aspect is to choose subscriber verification data, for example, in accordance with readily accessible data within the wireless network, such as the SN. It is highly unlikely that a subscriber will forget their own mobile telephone number. But, an aspect of the invention is to choose a combination of subscriber verification data 230 that is secure (for example, represents up to ten million or more choices) and is easily remembered by a subscriber.

At some point during the example being followed, the GSM standard requires the introduction of an octet to signal an appendix sub-address to identify a coding scheme for an appended sub-address. Depending on the numbering plan of the country in which the dialing intermediate or destination telephone is located, this appendix may begin and include the required octet after approximately the first six (international minimum) up to ten or eleven dialed digits (depending on the local requirement for a “1” prefix).

Finally, referring again to FIG. 2, call forward destination data 240 in the above example may be 201 825 1723, which is a destination telephone number located in New Jersey, a PSTN region of the United States. If an international destination, the destination data must include country code and city/region code plus local number. If the caller is calling from destination telephone 310 which bears the telephone number (201) 825 1723, the caller terminal identification is automatically forwarded to the wireless carrier 300. Consequently, the call forward destination data 240 need not even be entered at destination telephone 310. In stead, if accepted as a standard character, a * or # sign may signal the mobile switching center 340 to accept the caller identification data as the call forwarding number so as alert the adjunct network platform 350.

In the event the caller is calling from an intermediate telephone 320, the entire dial sequence representing the destination calling number must be received at either mobile switching center 340 or translated and sent or forwarded to network platform 350. Now, either mobile switching center 340 or network platform 350 will have to determine the proper format of call forward destination data 240 for forwarding calls from the wireless network to the destination telephone outside the network. In particular, the ten digit telephone number must be identified and conform to any requirement for entry of a “1” or other prefix data. Consequently, any home location register 360 data representing the call forward telephone number must be network appropriate for the given interface back to the public switched telephone network 330.

FIG. 2 suggests that the sequences 210, 220, 230 and 240 must be received in the order given. In fact, only sequence 210 is required first and the remaining data sequences 220, 230, 240 or portion of subscriber verification data 220 may be entered and received in different order. Nevertheless, the order must be predetermined or the remote call forwarding digit string will not be uniquely defined and conform to standards. Whenever the mobile switching center 340 or the network platform 350 are unable to interpret a dialed sequence, either may request the redialing of the sequence or default to an IVR apparatus 370 (FIG. 3a) if available or to a live agent or operator position, if available (not shown). The live agent or operator, located within the wireless network 300, may invoke requested remote call forwarding in a conventional manner via, for example, a direct link to the home location register 360 or via the internet

Because the entered dialing string will vary in length, the caller desirous of remote call forwarding may enter an end of data indicator preferably a # digit to signal the end of a dialed digit entry, for example, especially for a variable length PIN portion of subscriber identification data 230. The * may also be used as an end of data marker. Again, one preferred time for using the end of data entry is to define the length of a personal identifier. Since the SN is of fixed length, typically, four dialed digits, the personal identifier may be of four to, for example, seven or even more characters and the # may indicate the end of data. The entry of the end of data indicator at the end of a personal identifier string of digits or characters (not shown in FIG. 2) adds confidence to the decision making processes at a mobile switching center 340 or network platform 350. Similarly, the use of an end of data marker may be useful for signifying the end of destination call forward telephone number 240.

In an alternative embodiment according to FIGS. 2 and 3, the dialed number may include the prefix 1 800 (or related sequence) or 1 888 indicating a toll-free call or 1 900 (or related sequence) for causing a charge to be accorded to the wireless subscriber's bill for actuating the call forwarding service feature. In this embodiment, either a toll-free or toll prefix should be considered part of carrier routing string 210. Following this embodiment, consider 1-800, 1-888 or 1-900 followed by a string of XXXX as routing a call to at least mobile switching center 340 inside a wireless network. If the call via a toll prefix (1 900) is completed successfully and call forwarding invoked from the wireless network 300, the wireless network may charge a fixed fee for remote call forwarding to the subscriber using the service or measure the duration that the call forwarding service feature is invoked and so invoke a time varying fee.

FIG. 3a depicts a second routing embodiment where the network platform 350 depicted in FIG. 3 may comprise interactive voice response (IVR) apparatus 370 and associated software. In this embodiment, the first dialed digit data entry still comprises a carrier routing string 210 followed by, for example, an SN portion of the subscriber verification data 230 and service feature selection data 220. FIG. 3A assumes that the IVR apparatus 370 is associated with the network platform 350, but it may be associated with a mobile switching center 340 and within network 300.

IVR apparatus 370 comprises a pre-programmed script for remote call forwarding or other service which is selected according to service feature selection data 220 and uses as its initial input at least a seven to ten or eleven digit string of dialed digits, the initial purpose of which is carrier routing data 210, service feature selection data 220 and possibly if room permits, a portion of subscriber verification data 230. IVR apparatus 370 may proceed in querying for data in any order. For example, “Please enter the last four digits of your mobile device?” “Thank you. We are now verifying that data.” As a double check, and if already entered in the dialed digit routing sequence, the wireless network 300 may verify the dialed digits already entered perhaps twice against the subscriber's account records. “Now that we have verified that you have correctly identified your mobile device, please enter your personal identification number or PIN followed by the # sign?” As indicated above, the PIN may be of variable length. “Now that we have verified your PIN, please say yes or enter a * to indicate whether you are calling from the number to which you wish your calls to be forwarded or speak or dial its area code and seven digit telephone number, or if your ultimate destination telephone is outside the country please enter the country code, city code and telephone number of the number to which you wish your calls to be forwarded followed by the # sign.” The choice of text and sequence of queries may vary from this order and suggested text. In any event, the result is that call forwarding may be invoked from IVR apparatus and a home location register 370 updated to indicate the entered or spoken routing address 240 for call forwarding. The IVR apparatus 370 is virtually unlimited as to the features invoked. For example, a query/response script may continue to request cancellation data, follow me data and call screening data.

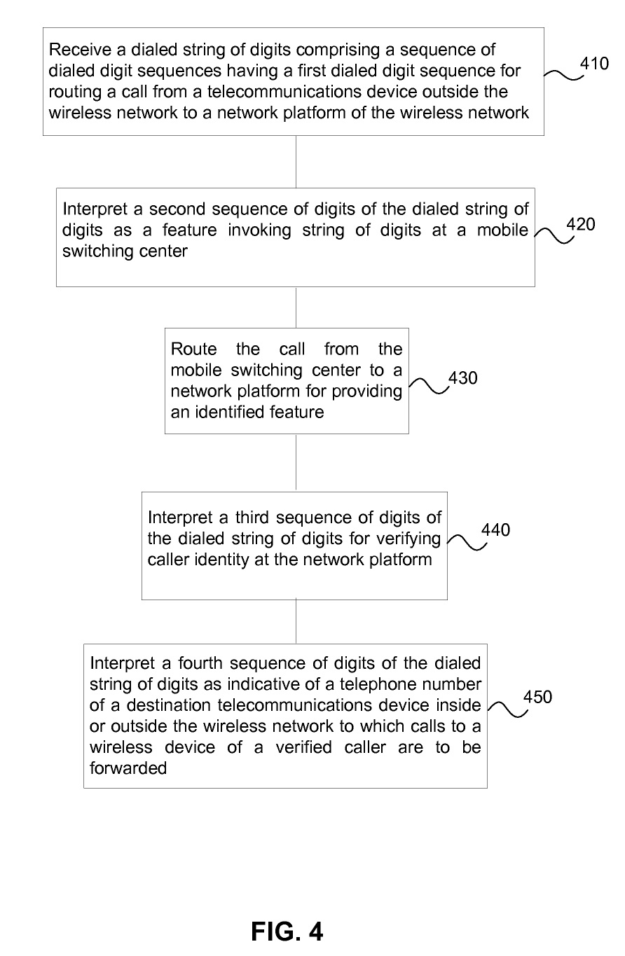

FIG. 4 is a simplified flowchart showing the processes of interpreting the exemplary dialing string of FIG. 2 and routing a call as per FIG. 3 for actuating remote call forwarding. Step 410 shows the step of receiving a dialed string of digits comprising a sequence of dialed digit sequences having a first dialed digit sequence 210 (FIG. 2) for routing a call from the telecommunications device inside or outside the wireless network 300 toward a network platform of the wireless network 300. This step as discussed above may be performed most conveniently at a mobile switching center 340 within wireless network 300. Step 420 shows the step of interpreting a second sequence of digits of the dialed string of digits (one or two dialed digits comprising an octet) as a feature invoking string of digits 220 at a mobile switching center 340. This feature selection digit may preferably comprise a single dialed digit such as a *. Also, this step 420 may be performed either at the mobile switching center 340 or at network platform 350. At least an SN may be entered before the feature selection string or octet generation step 220. Once a remote call forwarding service feature is identified, step 430 shows the step of routing the call from the mobile switching center 340 to a network platform 350 for providing an identified feature by digit 220, such as remote call forwarding. Since step 420 may be performed at either the mobile switching center 340 or the network platform 350, step 430 may be performed before step 420 (not shown). Similarly, step 440 shows the step of interpreting a third sequence of digits 230 of the dialed string of digits for verifying caller identity which may precede step 420 or 430. Preferably, the verification step includes a four digit SN and a PIN of four digits or other digit string ended with an end of data marker. This verification step 440 is performed within the wireless network 300 in any order with steps 420 and 430 depending on whether the step is performed at the mobile switching center 340 or the network platform 350 and when the GSM octet (one or two dialed digits) is entered. Finally, step 450 shows the step of interpreting a fourth sequence of digits of the dialed string of digits, which may be a single dialed digit, as indicative of a telephone number of a telecommunications device inside or outside the wireless network to which calls to a wireless device of a verified caller are to be forwarded. Step 450 may be performed at mobile switching center 340 or at network platform 350. Consequently, step 450 may be performed out of sequence and after step 410, 420, 430 or 440 depending on what order and at what network element (a mobile switching center or a network platform) the steps are performed. Step 450 may be a single digit entry to simply indicate that a caller identification number may be used as the call forward telephone number (the subscriber has reached their destination). As discussed above, further digit sequences of a GSM sub-address appendix may indicate expiration dates, follow-me schedules, call screening lists or other data associated with call forwarding.

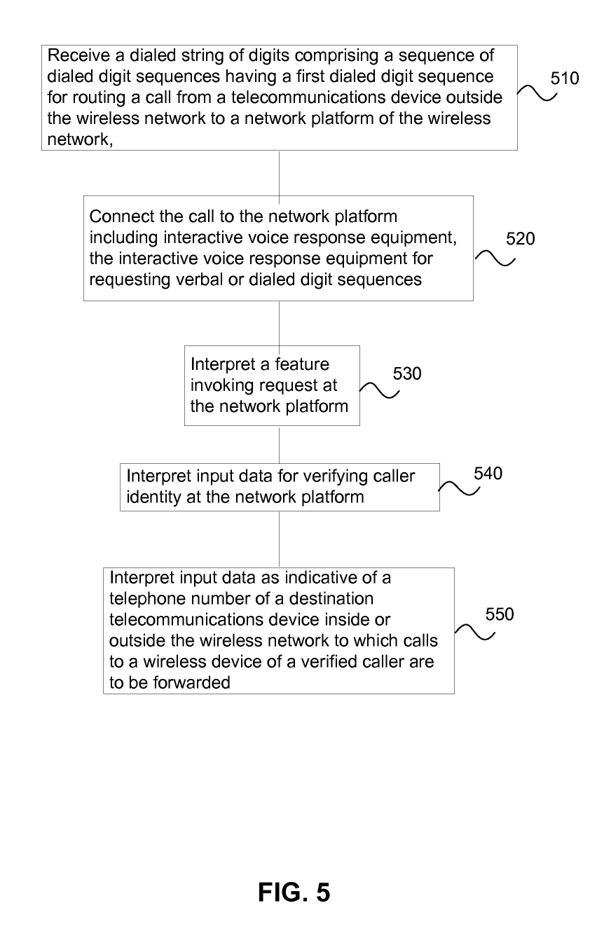

FIG. 5 is a simplified flowchart showing the processes of routing a call as per FIG. 3a to a network platform 350 associated with an interactive voice response system 370 (FIG. 3a) and actuating remote call forwarding via the interactive response system 370. Step 510 shows the step of receiving a dialed string of digits comprising a sequence of dialed digit sequences having a first dialed digit sequence 210 for routing a call from the telecommunications device 310, 320 inside (not requiring PSTN) or outside (requiring PSTN) the wireless network 300 toward a mobile switching center 340 or a network platform 350 of the wireless network 300. This step of receiving and processing carrier routing data 210 is typically performed at a mobile switching center 340 of wireless network 300. Step 520 shows the step of connecting the call to the network platform 350 including interactive voice response equipment 370, the interactive voice response equipment 370 for requesting verbal or dialed digit sequences. From here on, once IVR equipment 370 is associated with the call, the steps may be performed in any order. Step 530 shows the step of interpreting a service feature invoking request 220 at the network platform. In particular, as described above, the IVR equipment 370 needs to associate a feature invoking request with a predetermined set of queries and responses which queries may appear in any reasonable order. Step 540 shows the step of interpreting input data for verifying caller identity 230 at the network platform. For example, the caller may be asked to identify their account (SN) in the wireless network and a personal identification number or PIN followed by an end of data marker if not of fixed length.

Any alternate means may be used to identify and verify the subscriber (step 540) that is reasonable in the event any of this information fails the subscriber's memory. For example, as is known in the art, a mother's maiden name, their birthday, the name of a childhood pet or first home street name may be used as alternatives, for example, to a forgotten PIN. Step 550 shows the step of interpreting input data 240 as indicative of a telephone number of a telecommunications device outside the wireless network to which calls to a wireless device of a verified caller are to be forwarded. As indicated above, this data may simply be a yes or no indication to whether the subscriber has reached their destination and so caller identification data may be used to identify the call forwarding destination number. As discussed above, the query/response script may continue to inquire of service feature cancellation date and time, follow-me schedules, call screening lists and other data.

Thus, there has been described at least two different methods and various combinations of apparatus for remotely actuating call forwarding when the subscriber of a wireless network does not have their mobile device with them or have access to the internet. The call forwarding service feature or other features such as entering service feature cancellation date and time, a follow me list of telephone numbers and scheduled times or a list of priorities for receiving calls (such as a friends and family list versus junk mail) may be actuated from an intermediate phone or a destination phone inside or outside the network. In an alternative embodiment, the wireless network may have a toll-free or toll number or other routing data followed by sequences of data entry identifying the feature to be invoked, identifying the subscriber to the network and the destination to which the subscriber wishes their calls forwarded. Various aspects further include automatically adding “1”'s to destination numbers depending on the destination network's requirements, the required addition of an octet (typically, one or two dialed digits in the United States) to identify a sub-address appendix and feature under present standards to the dialing string when the dialed string reaches beyond a certain routing limit of digits, translating data within the wireless network for efficient transmission from a first connected point within a network to a network platform and use of end of data indicators to assist the wireless network to determine and interpret entered data sequences such as variable length personal identification numbers. While cancellation of remote call forwarding service has not been particularly discussed from inside or outside a wireless network and without access to the internet, one of ordinary skill in the art would recognize that at least routing information 210, service feature identification 220 and subscriber identification 230 must be accomplished by dialed digit entry or elements 220, 230 and interpreted, for example, via either digit string entry interpretation or via IVR equipment 370 within the wireless network in order to achieve service feature cancellation. Other variations and embodiments and aspects may come to mind and should only be deemed to be limited in scope by the claims which follow.

What we claim is:

1. A method of actuating call forwarding remotely in a wireless network from a telecommunications device inside or outside the wireless network comprising:
receiving a dialed string of digits comprising a sequence of dialed digit sequences having a first dialed digit sequence for routing a call from the telecommunications device to within the wireless network;
routing the call to wireless network apparatus for providing an identified service;
interpreting data representing a second sequence of dialed digits of the dialed string of digits for verifying caller identity within the wireless network;
interpreting data representing a third sequence of digits of the dialed string of digits as indicative of a telephone number of a telecommunications device inside or outside the wireless network to which calls to a wireless device of a verified caller are to be forwarded.

2. A method as recited in claim 1 further comprising the step of translating the second and third sequence of digits of the dialed string of digits into compressed data for transmission over a link to a network platform of the wireless network apparatus.

3. A method as recited in claim 1 wherein the second sequence of dialed digits comprises a subscriber number and a personal identifier code.

4. A method as recited in claim 3 further comprising the step of indicating the end of data entry of a personal identifier code by a special dialed digit following the second sequence of dialed digits.

5. A method as recited in claim 1 further comprising the step of indicating that a subscriber is calling from a destination telephone by receiving a special dialed digit to represent the third sequence of digits of the dialed string of digits.

6. A method as recited in claim 5 further comprising the step of recording the destination telephone number from caller identification number data in a location register of the wireless network responsive to receipt of the special dialed digit.

7. A method as recited in claim 1 further comprising the step of recording the destination telephone number from the third sequence of digits of the dialed string of digits in a location register of the wireless network.

8. A method as recited in claim 1 further comprising the steps of interpreting a received sequence of one or two dialed digits of the dialed string of digits as a service feature selecting sequence of digits within the wireless network.

9. A method as recited in claim 8 wherein the received sequence of digits comprises a single digit for selecting one feature and represents a GSM octet for identifying a sub-address appendix following routing data.

10. A method of actuating call forwarding remotely from a telecommunications device inside or outside a wireless network comprising:
receiving a dialed string of digits comprising a sequence of dialed digit sequences having a first dialed digit sequence for routing a call from the telecommunications device to within the wireless network;
connecting the call to network apparatus in the wireless network including interactive voice response equipment, the interactive voice response equipment for requesting verbal responses or dialed digit sequences;
interpreting a service feature invoking request at the network apparatus;
interpreting input data or an intelligible response for verifying caller identity at the network apparatus;
interpreting input data or an intelligible response as indicative of a telephone number of a telecommunications device inside or outside the wireless network to which calls to a wireless device of a verified caller are to be forwarded.

11. A method as recited in claim 10 further comprising the step of translating caller identity data into compressed data for transmission over a link to a selected network platform having interactive voice response.

12. A method as recited in claim 10 further comprising the step of indicating an end of data entry by a special dialed digit following the entry of caller identity data.

13. A method as recited in claim 10 further comprising the step of indicating that a subscriber is calling from a destination telephone by receiving a special dialed digit to represent the telecommunications device to which calls are to be forwarded.

14. A method as recited in claim 13 further comprising the step of recording the destination telephone number from caller identification number data in a location register of the wireless network.

15. A method as recited in claim 10 further comprising the step of recording the voiced or dialed destination telephone number in a location register of the wireless network.

16. A network platform of a wireless network to which an incoming call has been routed by a mobile switching center within the wireless network, the network platform being connected to the incoming call according to a first dialed digit sequence of a dialed string of digits comprising a plurality of dialed digit sequences, the network platform comprising:
a controller having access to a location register, the controller interpreting a second sequence of digits of the dialed string of digits for verifying caller identity at the network platform, and interpreting a third sequence of digits of the dialed string of digits as indicative of a telephone number of a telecommunications device inside or outside the wireless network to which calls to a wireless device of a verified caller are to be forwarded; and
the location register, responsive to a control signal from the network platform, indicating routing information for the incoming call to be routed according to the third sequence of digits.

17. A network platform as recited in claim 16 wherein network apparatus interprets a sequence of digits comprising one or two dialed digits representing a GSM octet for identifying a sub-address appendix, the dialed digits used for forwarding incoming call data to a selected network platform.

18. A network platform as recited in claim 16 wherein the third sequence of digits comprises a single digit indicative that the location register is to record caller identification number data as the call forward destination number.

19. A network platform of a wireless network to which an incoming call has been routed from inside or outside the wireless network by a mobile switching center within the wireless network, the network platform being connected to the incoming call according to a first dialed digit sequence of a dialed string of digits comprising a plurality of dialed digit sequences, comprising:
a controller having access to a location register, the controller having an associated interactive voice response system, receiving first data responsive to a voice request of the interactive voice response system, interpreting the first data for verifying caller identity at the network platform, and receiving second data responsive to a voice request of the interactive voice response system, and interpreting the second data as indicative of a telephone number of a telecommunications device outside the wireless network to which calls to a wireless device of a verified caller are to be forwarded; and
the location register, responsive to a control signal from the network platform, indicating routing information for subsequent incoming calls to a mobile device associated with the caller identity data to be routed according to the second data.

20. A network platform as recited in claim 19 wherein the interactive voice response system receives variable length keyed data as a personal identifier and accepts a special keyed character as an indicator of the end of personal identifier data entry.

21. A network platform as recited in claim 19 wherein the interactive voice response system receives data representing the subscriber number and a variable length personal identifier as verification data for the subscriber.

22. A network platform as recited in claim 19 wherein the interactive response system receives in response to a query a single keyed or spoken entry as indicative of an entire sequence of dialed digits representing the destination telephone number to which calls are to be forwarded, the single keyed or spoken entry indicating that a call is being received from a subscriber's destination.

23. A network platform as recited in claim 19 further comprising the steps of receiving data responsive to a voice request of the interactive voice response system, interpreting the data as further service feature data, the further feature data comprising one of feature cancellation data, follow-me data and screening data.
